(19) United States
(12) Patent Application Publication
(10) Pub. No.: US 2007/0103072 A1
(43) Pub. Date: May 10, 2007

(54) Plasma display panel (PDP)

(76) Inventors: Yoshitaka Terao, Yokohama-shi (JP); Yukika Yamada, Yokohama-shi (JP); Takashi Miyama, Yokohama-shi (JP)

Correspondence Address: Robert E. Bushnell;Suite 300, 1522 K Street, N.W., Washington, DC, 20005-1202, US

(21) Appl. No.: 11/591,503

(22) Filed: Nov. 2, 2006

(30) Foreign Application Priority Data
Nov. 4, 2005 (JP) 2005-321386

(51) Int. Cl. H01J 17/49

(52) U.S. Cl. 313/582; 313/584; 313/585

(57) ABSTRACT

A Plasma Display Panel (PDP) includes a front substrate, a rear substrate arranged to face the front substrate, and a discharge gas contained between the front substrate and the rear substrate. The front substrate includes a transparent substrate, and a plurality of X electrodes and Y electrodes formed to extend in parallel to each other along a first direction on the surface of the transparent substrate facing the rear substrate, and arranged alternately and facing each other with respect to a second direction crossing the first direction. The rear substrate includes an insulating substrate, an address electrode formed to extend along the second direction on the surface of the insulating substrate, and a phosphor layer formed on the surface of the insulating substrate. At least part of the phosphor layer is disposed between the respective X electrodes and Y electrodes.

### CLAIM OF PRIORITY

This application makes reference to, incorporates the same herein, and claims all benefits accruing under 35 U.S.C. §119 from an application for PLASMA DISPLAY PANEL earlier filled in the Korean Intellectual Property Office on the 4th of Nov. 2005 and there duly assigned Ser. No. 2005-321386.

### BACKGROUND OF THE INVENTION

1. Field of the Invention

The present invention relates to a Plasma Display Panel (PDP), and more particularly, to an AC PDP in which sustain electrodes face each other.

2. Description of the Related Art

A Plasma Display Panel (PDP) includes a front substrate arranged on a display surface side and a rear substrate arranged to face the front substrate, with a discharge gas such as an inert gas/rare gas filled there between.

On the front substrate, an X electrode and a Y electrode extending in a horizontal direction of a display screen, for example, are formed over a transparent substrate such as a glass substrate. The X electrode and the Y electrode are referred to as sustain electrodes.

On the rear substrate, an address electrode extending in a vertical direction of a display screen, for example, is formed over an insulating substrate such as a glass substrate, and a white dielectric layer is formed to cover the address electrode.

On the white dielectric layer, lattice-shaped or stripe-shaped barrier ribs are formed. The barrier ribs partition a space between the front substrate and the rear substrate into a plurality of discharge cells. A phosphor layer is coated on lateral sides of the barrier ribs and on surfaces of the white dielectric layer.

Therefore, when a discharge is generated between the X electrode and the Y electrode, vacuum ultraviolet rays generated due to the discharge are irradiated onto the phosphor layer, thus allowing the phosphor layer to emit visible light.

In a prior art PDP of a surface discharge structure, sustain electrodes are formed in a planar shape on a transparent substrate, and a transparent dielectric layer is formed while covering the sustain electrodes. In order to enhance luminous efficiency with regard to this issue, a PDP of a facing discharge type of electrode structure in which sustain electrodes face each other is disclosed in Japanese Laid-Open Patent No. 2003-151449.

FIG. 12 is a partial cross-sectional of a prior art PDP 101 having a facing discharge electrode structure, as discussed in Japanese Laid-Open Patent Application No. 2003-151449. In FIG. 12, a front substrate 102 and a rear substrate 103 face each other, and a discharge gas is contained within a space therebetween.

A glass substrate 105 is formed on the front substrate 102. An X electrode 106 and a Y electrode 107 are formed on the surface of the glass substrate 105 facing the rear substrate 103 to extend alternately in parallel with each other.

The X electrode 106 includes a bus electrode 106a contacting the glass substrate 105 and made of a conductive material, and a dielectric layer 106b not contacting the glass substrate 105 and covering the surface of the bus electrode 106a.

Like the X electrode 106, the Y electrode 107 includes a bus electrode 107a made of a conductive material and a dielectric layer 107b covering the bus electrode 107a.

Ribs (not shown) interconnecting these electrodes are formed between the X electrode 106 and the Y electrode 107. These ribs are barrier ribs defining a plurality of discharge cells 110 along with the X electrode 106 and the Y electrode 107.

A protective film 108 made of magnesium oxide (MgO) is formed to cover the glass substrate 105 and the barrier ribs.

Since no component other than the protective film 108 is arranged between the X electrode 106 and Y electrode 107 of each discharge cell 110, a discharge path is formed with only a discharge gas therebetween in the discharge cell 110.

A glass substrate 111 is formed on the rear substrate 103, and an address electrode 112 is formed on the surface of the glass substrate 111 facing the front substrate 102.

The address electrode 112 is formed to extend in a direction orthogonal to the direction in which the X electrode 106 and the Y electrode 107 extend.

A white dielectric layer 113 covering the address electrode 112 is formed on the glass substrate 111, and lattice-shaped barrier ribs 114 are formed on the white dielectric layer 113. The barrier ribs 114 are arranged at positions corresponding to barrier ribs formed on the front substrate 102. A phosphor layer 115 is formed on lateral sides of the barrier ribs 114 and surfaces of the white dielectric layer 113.

In the thus-constructed prior art PDP 101, when a voltage is supplied to the bus electrode 106a of the X electrode 106 and the bus electrode 107a of the Y electrode 107, vacuum ultraviolet rays are generated due to a gas discharge between the X electrode 106 and the Y electrode 107.

When these ultraviolet rays are irradiated onto the phosphor layer 115, the phosphor layer 115 emits visible light. The visible light penetrates the glass substrate 105 of the front substrate 102, to display images on the display surface of the PDP 101. By controlling a number of discharges in each of the discharge cells 100 within 1 field displaying 1 screen, images can be displayed on the entire PDP 101.

However, the prior art facing discharge PDP 101 having the electrode structure of FIG. 12 also has a problem in that when the distance from ultraviolet rays generated by the discharge occurring between the sustained electrodes to the phosphor layer is too long, the utilization efficiency of the ultraviolet rays is lowered, resulting in a reduced luminous efficiency.

### SUMMARY OF THE INVENTION

The present invention has been made in an effort to solve the above-described problems, and to provide a Plasma Display Panel (PDP) having a high luminous efficiency.

To accomplish the above aspect, a Plasma Display Panel (PDP) is provided including: a front substrate; a rear substrate arranged to face the front substrate; and a discharge gas contained between the front substrate and the rear substrate; the front substrate includes: a transparent substrate; and a plurality of X electrodes and Y electrodes extending in parallel to each other along a first direction on a surface of the transparent substrate facing the rear substrate, and arranged alternately to face each other with respect to a second direction crossing the first direction; the rear substrate includes: an insulation substrate; an address electrode extending along the second direction on a surface of the insulating substrate; and a phosphor layer arranged on the surface of the insulating substrate; and least part of the phosphor layer is arranged between the respective X electrodes and Y electrodes.

The respective X and Y electrodes preferably each include: a bus electrode of a conductive material; and a conductive material and a dielectric layer surrounding the bus electrode.

At least part of the phosphor layer is preferably arranged between the respective bus electrode of the X electrode and the bus electrode of the Y electrode. The phosphor layer preferably protrudes toward the front substrate from the surface of the insulating substrate.

A shape of a cross-section of the phosphor layer cut in a direction perpendicular to a horizontal surface of the rear substrate is preferably at least one of a cascade, a triangle, a part of a circle, a trapezoid, or a rectangle shape. The phosphor layer preferably further includes a plurality of projections protruding toward the front substrate, the plurality of protrusions preferably having depressions spaced therebetween.

The rear substrate preferably includes a base portion protruding toward the front substrate from the surface of the insulating substrate, and the phosphor layer preferably covers the base portion. The base portion is preferably arranged at a region between the respective X electrodes and Y electrodes on the surface of the insulating substrate. The base portion preferably includes layers in a pyramid shape. The base portion preferably includes a dielectric material.

The front substrate preferably further includes ribs crossing the X electrodes and the Y electrodes on the surface of the transparent substrate, and the ribs preferably define discharge cells along with the X electrodes and the Y electrodes.

The rear substrate preferably further includes barrier ribs on a side of the rear substrate corresponding to the X electrodes, the Y electrodes, and the ribs on the surface of the insulating substrate, and the barrier ribs preferably protrude to define discharge cells. The rear substrate preferably includes a white dielectric layer covering the address electrode on the surface of the insulating substrate, and the white dielectric layer preferably includes grooves corresponding to the ribs. The grooves are preferably wider than the ribs.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a partial plane view of a Plasma Display Panel (PDP) in accordance with a first exemplary embodiment of the present invention.

FIG. 2 is a partial cross-sectional view taken along line A-A of FIG. 1.

FIG. 3 is a partial cross-sectional view taken along line B-B of FIG. 1.

FIG. 4 is a partial cross-sectional view of as PDP in accordance with a second exemplary embodiment of the present invention.

FIG. 5 is a partial cross-sectional view of a PDP in accordance with a third exemplary embodiment of the present invention.

FIG. 6 is a partial cross-sectional view of a phosphor layer and its peripheral portions in a fourth exemplary embodiment of the present invention.

FIG. 7 is a partial cross-sectional view of a phosphor layer and its peripheral portions in a fifth exemplary embodiment of the present invention.

FIG. 8 is a partial cross-sectional view of a phosphor layer and its peripheral portions in a sixth exemplary embodiment of the present invention.

FIG. 9 is a partial cross-sectional view of a phosphor layer and its peripheral portions in a seventh exemplary embodiment of the present invention.

FIG. 10 is a partial cross-sectional view of a phosphor layer and its peripheral portions in an eighth exemplary embodiment of the present invention.

FIG. 11 is a partial cross-sectional view of a phosphor layer and its peripheral portions in a ninth exemplary embodiment of the present invention.

FIG. 12 is a partial cross-sectional view of a prior art PDP having a facing discharge electrode structure.

### DETAILED DESCRIPTION OF THE INVENTION

Hereinafter, the present invention is described more fully with reference to the accompanying drawings, in which embodiments of the present invention are shown. As those skilled in the art would realize, the described embodiments can be modified in various different ways, all without departing from the spirit or scope of the present invention.

In the drawings, many of the details of a Plasma Display Panel (PDP) that are not relevant to the present invention have been omitted for the sake of clarity. Like reference numerals designate like elements throughout the specification.

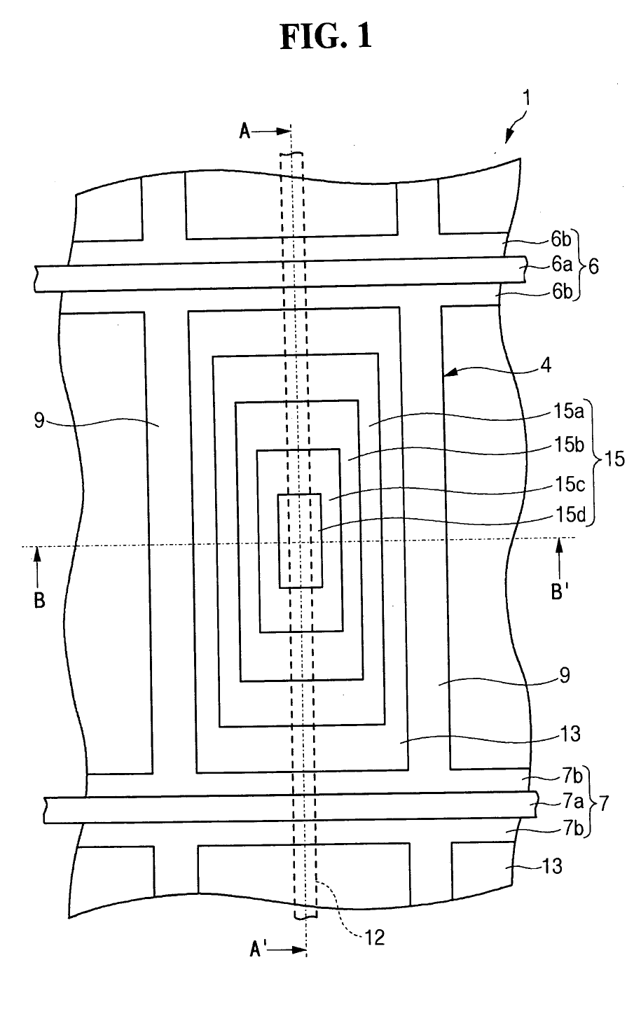

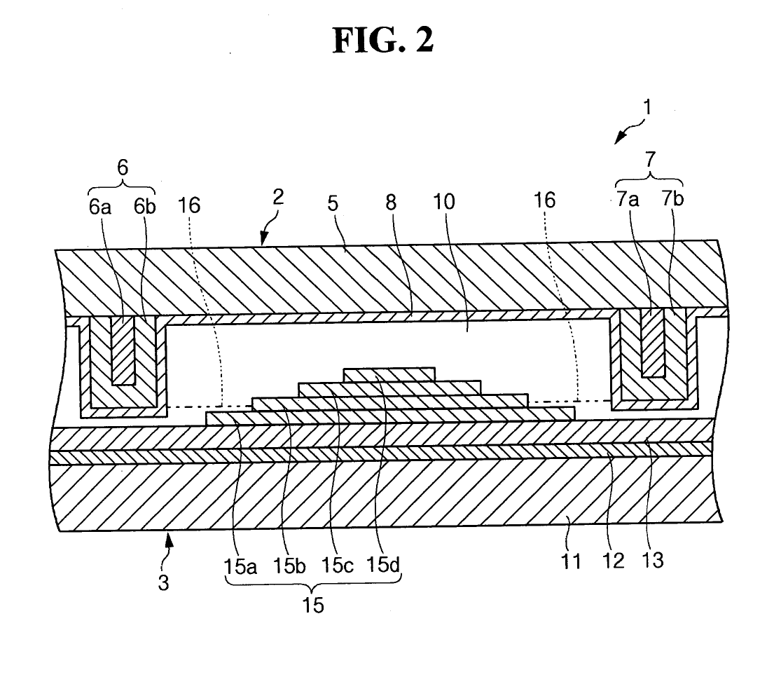

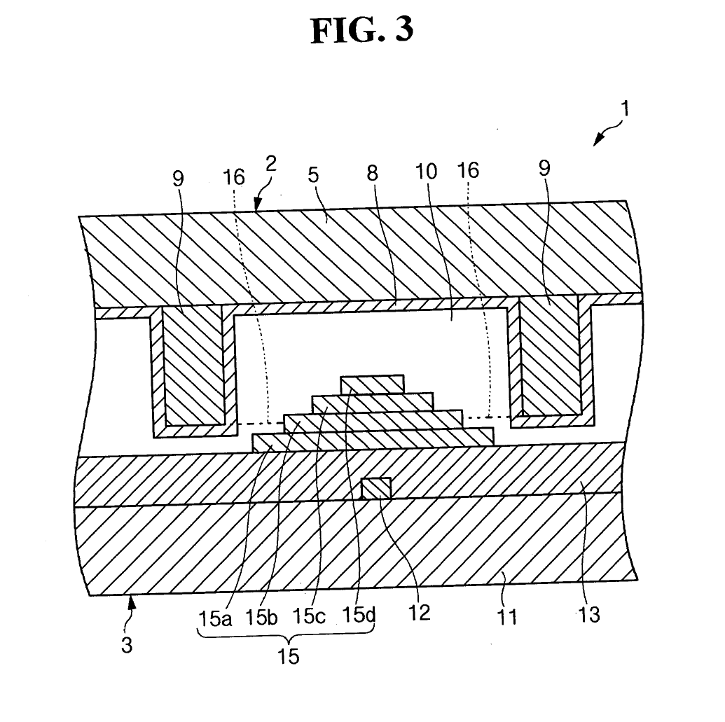

FIG. 1 is a partial plane view of a PDP in accordance with a first exemplary embodiment of the present invention, FIG. 2 is a partial cross-sectional view taken along line A-A of FIG. 1, and FIG. 3 is a partial cross-sectional view taken along line B-B of FIG. 1.

As shown in FIGS. 1 to 3, the PDP according to the present embodiment is an Alternating Current (AC) PDP. The PDP 1 includes a front substrate 2 and a rear substrate 3 arranged parallel to and facing each other, with a discharge gas contained within a space therebetween.

The discharge gas is an inert gas/rare gas, for example, a Ne—Xe mixed gas that contains 7 to 15% by volume of Xenon (Xe), and whose remaining part is Neon (Ne).

On the front substrate 2, a glass substrate 5 serving as a transparent substrate is used, and X electrodes 6 and Y electrodes 7 extending in parallel to each other along a first direction (i.e., a horizontal direction of a display screen) are formed on the surface of the glass substrate facing the rear substrate 3.

The X electrodes 6 and the Y electrodes 7 are arranged alternately and face each other at a predetermined distance apart with respect to a second direction (i.e., vertical direction of a display screen) crossing the first direction.

The X electrodes 6 and the Y electrodes 7 are referred to as sustain electrodes.

Each X electrode 6 includes a bus electrode 6a made of a conductive material and contacting the glass substrate 5, and a dielectric layer 6b surrounding the bus electrode 6a. Likewise, each Y electrode 7 includes a bus electrode 7a made of a conductive material and a dielectric layer 7b covering the bus electrode 7a.

In the present specification, the X electrodes and Y electrodes respectively include conductive bus electrodes 6a and 7a constituting the respective X and Y electrodes, as well as dielectric layers 6b and 7b respectively surrounding the bus electrodes 6a and 7a.

The bus electrodes 6a and 7a can be formed, for example, by applying silver paste and then sintering it. The silver paste is made of a material containing silver (Ag) and an inorganic binder. The dielectric layers 6b and 7b can be made of low melting point glass, such as lead glass.

Ribs 9 extending in a second direction orthogonal to the first direction in which the two electrodes extend and interconnecting the two electrodes are formed between the X electrodes 6 and the Y electrodes 7.

The ribs 9 can be formed, for example, of the same low melting point glass material, such as lead glass, as are the dielectric layers 6b and 7b. The ribs 9 constitute lattice-shaped barrier ribs 4 along with the X electrodes 6 and the Y electrodes 7. The barrier ribs 4 partition a space between the front substrate 2 and the rear substrate 3 into a plurality of discharge cells.

A protective film 8 is formed to cover the glass substrate 5 and the barrier ribs 4. The protective film 8 is made of magnesium oxide (MgO), and it prevents the glass substrate 5 and the barrier ribs 4 from being damaged due to sputtering caused by a gas discharge, and at the same time, supplies secondary electrons into the discharge cells 10 to reduce a discharge start voltage.

Although FIG. 1 is a plane view of the PDP 1 viewed from the front substrate side, the glass substrate 5 and the protective film 8 have been omitted for clarity.

On the rear substrate 3, a glass substrate 11 serving as an insulating substrate is used, and an address electrode 12 is formed on the surface of the side facing the front substrate 2 of the glass substrate 11.

The address electrode 12 is formed to extend in the second direction orthogonal to the first direction in which the X electrodes 6 and the Y electrodes 7 extend. When viewed from the side of the front substrate 2, a central portion of each discharge cell 10 is arranged so that one address electrode 12 passes through it.

The address electrode 12 can be formed by applying a silver paste and then sintering it. The silver paste is made of a material containing silver (Ag) and an inorganic binder.

A white dielectric layer 13 covering the address electrode 12 is formed on the glass substrate 11.

In terms of design, a process margin of approximately 10 μm is provided between the white dielectric layer 13 and the barrier ribs 4. Thus, a gap of approximately 10 μm is formed between the white dielectric layer 13 and the barrier ribs 4.

However, due to a deviation in the height of the barrier ribs 4, part of the barrier ribs 4 may contact the white dielectric layer 13.

A phosphor 15 is formed on the white dielectric layer 13. The phosphor layer 15 emits visible light of any one of red (R), green (G), and blue (B) when ultraviolet light is incident thereon.

The present exemplary embodiment illustrates a case in which the phosphor layer 15 is formed in a plurality of layers.

The phosphor layer 15 has a first layer 15a being in contact with the white dielectric layer 13, and patterned in a rectangular shape, and a second layer 15b patterned in a rectangular shape formed on the first layer.

The outer circumference of the second layer 15b is positioned on an inner side of the outer circumference of the first layer 15a when viewed from the side of the front substrate 2.

A third layer 15c patterned in a rectangular shape is formed on the second layer 15b, and a fourth layer 15d patterned in a rectangular shape is formed on the third layer 15c.

The outer circumference of the third layer 15c is positioned on an inner side of the outer circumference of the second layer 15b when viewed from the side of the front substrate 2. The outer circumference of the fourth layer 15d is positioned on an inner side of the outer circumference of the third layer 15c when viewed from the side of the front substrate 2.

The first, second, third, and fourth layers 15a to 15d of the phosphor layer 15 are formed in layers in a pyramid shape. When viewed in the first direction in which the X electrodes 6 and the Y electrodes 7 extend, a cross-section of the phosphor layer 15 is formed in a cascade shape whose middle portion is high and both end portions are low.

Consequently, the portion of the phosphor layer 15 disposed between the X electrodes 6 and the Y electrodes 7 protrudes toward the front substrate 2.

As shown in FIGS. 2 and 3, in the phosphor layer 15, the upper part of the second layer 15b, the entire part of the third layer 15c, and the entire part of the fourth layer 15d are disposed closer to the glass substrate 5 than a virtual line 16 connecting the front end of the X electrodes 6 and the front end of the Y electrodes is to the glass substrate 5.

In other words, at least part of the phosphor layer 15 is disposed between the X electrodes 6 and the Y electrodes 7. That is, the upper part of the fourth layer 15d is disposed between the bus electrodes 6a of the X electrodes 6 and the bus electrodes 7a of the Y electrodes 7.

To help understanding, an example of the dimensions of each of the elements of the PDP 1 is stated below. However, the present invention is not necessarily limited to these dimensions.

The distance between central lines of the adjacent X electrode 6 and Y electrode 7 is approximately 700 μm, and the distance between central lines of the adjacent ribs 9 is approximately 300 μm. The height of the X electrodes 6 and Y electrodes 7 is approximately 100 to 500 μm, and the height of the bus electrodes 6a and 7a is approximately 50 to 400 μm.

The thickness of the white dielectric layer 13 is approximately 20 to 30 μm, and the height of the address electrode 12 is approximately 5 μm.

Hereinafter, a method of manufacturing a PDP 1 in accordance with the present exemplary embodiment is described.

First, a method of preparing a front substrate 2 is described below.

In the method of manufacturing the front substrate 2, firstly, a photosensitive silver paste is printed on the entire surface of a glass substrate 5 by a screen printing method. Predetermined regions where bus electrodes 6a and 7a are to be formed are exposed by using a mask and the other regions are covered, and the silver paste is exposed and developed. Accordingly, the silver paste is patterned.

The glass substrate 5 and the silver paste are sintered at a temperature of approximately 520 to 600° C. The sintering temperature of 520 to 600° C. is an appropriate temperature at which the silver paste is sintered but the glass substrate 5 is not softened. Accordingly, bus electrodes 6a and 7a are formed on the glass substrate 5.

A transparent dielectric material formed at a desired thickness using a coating method is patterned by a sand blast method, thereby forming a transparent dielectric pattern on the glass substrate 5 at the regions covering the bus electrodes 6a and 7a and the region where ribs 9 are to be formed.

The glass substrate 5 is baked at a temperature of approximately 520 to 600° C. at which the transparent dielectric material is sintered and the glass substrate 5 is not softened.

Accordingly, dielectric layers 6b and 7b are formed so as to respectively cover the bus electrodes 6a and 7a, and at the same time, ribs 9 are formed to complete the barrier ribs 4. Afterwards, MgO is coated on the entire surface to form a protective film 8, so that the glass substrate 5 and the barrier ribs 4 are covered. Accordingly, the front substrate is prepared.

Apart from the front substrate 2, a rear substrate 3 is prepared.

Firstly, an address electrode 12 is formed on a glass substrate 11 by the same method as the method of forming the above-described bus electrodes 6a and 7a on the glass substrate 11. Next, a white dielectric layer 13 is formed on the entire surface of the glass substrate 11 so as to cover the address electrode 12.

A first layer 15a made of phosphor and patterned in a rectangular shape is formed on the white dielectric layer 13 by a screen printing method or the like. Afterwards, a second layer 15b patterned in a rectangular shape smaller than the first layer 15a is formed on the first layer 15a.

In the same method, a third layer 15c patterned in a rectangular shape smaller than the second layer 15b is formed on the second layer 15b, and a fourth layer 15d patterned in a rectangular shape smaller than the third layer 15c is formed on the third layer 15d. Accordingly, the rear substrate 3 is prepared.

If the number of layers of the phosphor layer 15 is n, the process of forming the layers by screen printing is repeated n times while gradually making the pattern smaller.

Next, a sealing frit is formed on the circumference of the surface of the front substrate 2 or rear substrate 3 so as to surround the regions where the barrier ribs 4 are formed. Then, the front substrate 2 and the rear substrate 3 are joined together.

A first direction in which an X electrodes 6 and a Y electrodes 7 extend and a second directions in which the address electrode extends are orthogonal to each other. When viewed from the side of the front substrate 2, one address electrode 12 passes through the center of each discharge cell 10 defined by the barrier ribs 4.

Thereafter, the sealing frit is baked at a temperature of approximately 450° C.

Air is exhausted from the inside of a space surrounded by the front substrate, rear substrate 3, and sealing frit, and the space is filled with a discharge gas and sealed. Accordingly, the PDP 1 is manufactured.

Hereinafter, the operation of a PDP according to the present exemplary embodiment is described.

In the PDP 1, 1 field displaying 1 screen is divided into a plurality of subfields, and each subfield is driven and controlled so as to sequentially pass through an initialization period, a write period, and a sustain period.

In the initialization period, all discharge cells 10 are forcibly discharged to initialize the distribution of charges.

In the write period, by selectively supplying a voltage to an address electrode 12 while scanning the X electrodes 6 or the Y electrodes 7, a write discharge occurs within the discharge cell 10 desired to emit light in the subfields, to thus form a wall charge.

In the sustain period, when an alternating current is supplied between the bus electrodes 6a of the X electrodes 6 and the bus electrodes 7a of the Y electrodes 7, the alternating current and the wall charge are overlapped only in the discharge cell 10 where the wall charge is formed, and a sustain discharge occurs between the X electrodes 6 and the Y electrodes 7.

Due to this sustain discharge, ultraviolet rays having a wavelength of approximately 1.47 nm are generated. When these ultraviolet rays are incident on the phosphor layer 12, the phosphor layer 12 emits visible light. The visible light penetrates a transparent dielectric layer 8 of the front substrate 2 and the glass substrate 5, and realizes images through a display surface of the PDP 1.

In each discharge cell 10, the bus electrode 6a and the dielectric layer 6b function integrally as the X electrode 6, the bus electrode 7a and the dielectric layer 7b function integrally as the Y electrode, and a discharge path is formed between the X electrode 6 and the Y electrode 7. Due to this, ultraviolet rays are generated between the X electrodes 6 and the Y electrodes 7.

In the PDP 1 in accordance with the present exemplary embodiment, since the phosphor layer 15 is arranged between the X electrodes 6 and the Y electrodes 7, it is possible to shorten the distance between the ultraviolet ray generating portion and the phosphor layer 15 by shortening the distance between the discharge path and the phosphor layer 15. Due to this, the generated ultraviolet rays can be efficiently converted into visible light.

The phosphor layer 15 has a pyramid shape and the central portion thereof protrudes toward the front substrate 2. Thus, the surface of the phosphor layer 15 is arranged along the discharge path. Accordingly, the utilization efficiency of ultraviolet rays is further improved.

By differentiating the number of sustain discharges of a plurality of subfields of 1 field, a combination of subfields for light emission for each discharge cell 10 is selected, so that the number of discharges generated within 1 field for each discharge cell 10 can be selected and gray levels can be represented. Accordingly, images can be displayed on the entire part of the PDP 1.

Hereinafter, the effects of the present exemplary embodiment are described.

By disposing at least part of the phosphor layer 15 between the X electrodes 6 and the Y electrodes 7, the PDP of the present exemplary embodiment can reduce the distance between the ultraviolet ray generating portion and the phosphor layer 15 in comparison with the prior art PDP, and accordingly, can increase the utilization efficiency of ultraviolet rays.

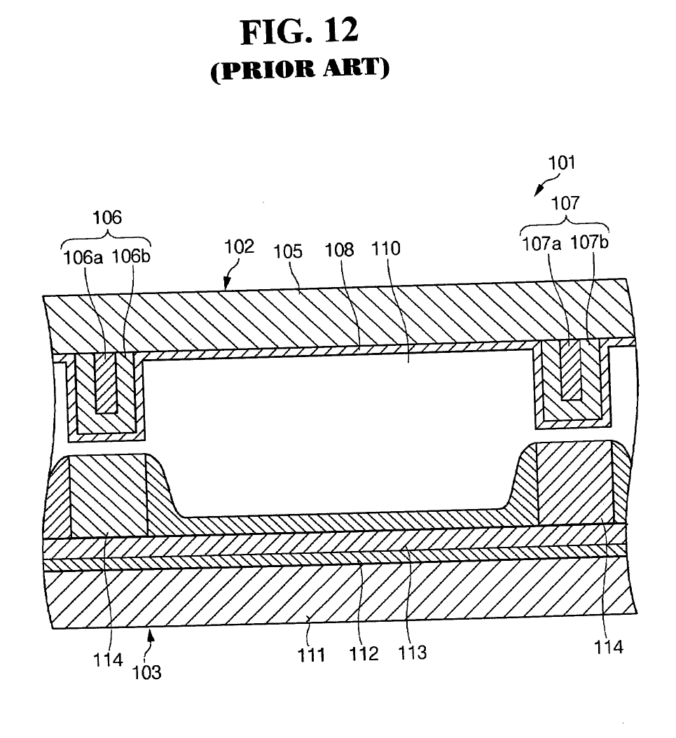

In other words, in the prior art PDP 101 of FIG. 12, the distance to the phosphor layer 115 from the ultraviolet rays generated by a discharge formed between the X electrodes 106 and the Y electrodes 107 is far. Due to this, the utilization efficiency of the ultraviolet rays generated by the discharge is deteriorated.

In contrast, in the present exemplary embodiment, the distance from the ultraviolet ray generating portion to the phosphor layer 15 can be shortened to a great extent by disposing at least part of the phosphor layer 15 between the X electrodes 6 and the Y electrodes 7.

Subsequently, the distance between the ultraviolet ray generating portion and the phosphor layer 15 can be shortened, and the utilization efficiency of the ultraviolet rays can be increased.

By protruding the central portion of the phosphor layer 15 toward the front substrate 2, the ultraviolet rays can be converted into visible light more efficiently.

Additionally, in the present exemplary embodiment, since the address electrode 12 is formed on the rear substrate 3, the aperture ratio can be increased in comparison with a case in which the address electrode is disposed on the front substrate, and accordingly the utilization efficiency of visible light can be increased.

Additionally, since a facing discharge type of electrode structure in which the X electrodes 6 and the Y electrodes 7 face each other is employed, a discharge start voltage can be reduced to increase luminous efficiency in comparison with a case in which a surface discharge type of electrode structure is employed.

Additionally, since there is no need to form a transparent dielectric layer on the entire surface of the front substrate, the transmittance of visible light to the front substrate can be increased, and the utilization efficiency of the visible light can be increased.

Hereinafter, a second embodiment of the present invention is described.

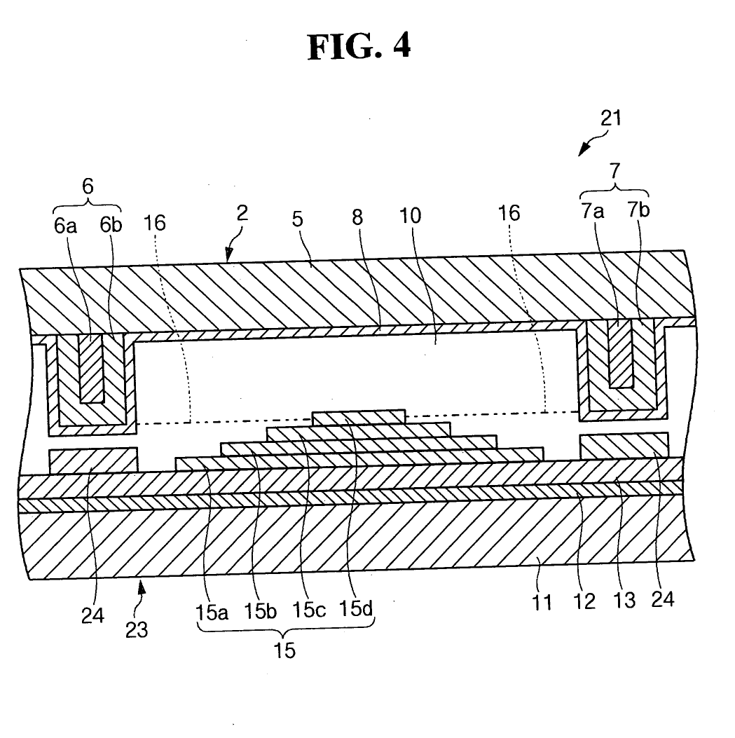

FIG. 4 is a partial cross-sectional view of a PDP in accordance with a second exemplary embodiment of the present invention. A cross-section as shown in FIG. 4 is equivalent to the cross-section taken along line A-A of FIG. 1.

In the PDP 21 according to the present exemplary embodiment, barrier ribs 24 are disposed on a white dielectric layer 13 of a rear substrate 23. The barrier ribs 24 can be formed of a low melting point glass, such as lead glass.

The barrier ribs 24 have a lattice shape when viewed from the side of the front substrate, and are formed to correspond to the barrier ribs 4 of the front substrate 2.

In terms of design, a process margin of approximately 10 μm is provided between the barrier ribs 4 of the front substrate 2 and the barrier ribs 24 of the rear substrate 23. Thus, a gap of approximately 10 μm is formed between the barrier ribs 4 and the barrier ribs 24. However, due to a deviation in the height of the barrier ribs 4 and barrier ribs 24, the barrier ribs 4 and the barrier ribs 24 may partially contact each other.

In this case, the barrier ribs 4 and the barrier ribs 24 are formed separately from each other. Accordingly, since the barrier ribs 24 are formed separately from the X electrodes 6 and the Y electrodes 7, they do not function as part of the electrodes.

In the process of manufacturing the PDP, the gap formed between the barrier ribs 4 and the barrier ribs 24 is used as a gas passage for charging a discharge gas in each discharge cell.

In the present exemplary embodiment, as part of the phosphor layer 15 is disposed closer to the glass substrate 5 than a virtual line 16 is, it is arranged between the X electrodes 6 and the Y electrodes 7. For example, the upper part of the fourth layer 15d of the phosphor layer 15 is disposed between the X electrodes 6 and the Y electrodes 7. However, the phosphor layer 15 is not disposed between the bus electrodes 6a and the bus electrodes 7a.

The other configurations, operations, and effects of the present exemplary embodiment are identical to those of the first exemplary embodiment.

Hereinafter, a third embodiment of the present invention is described.

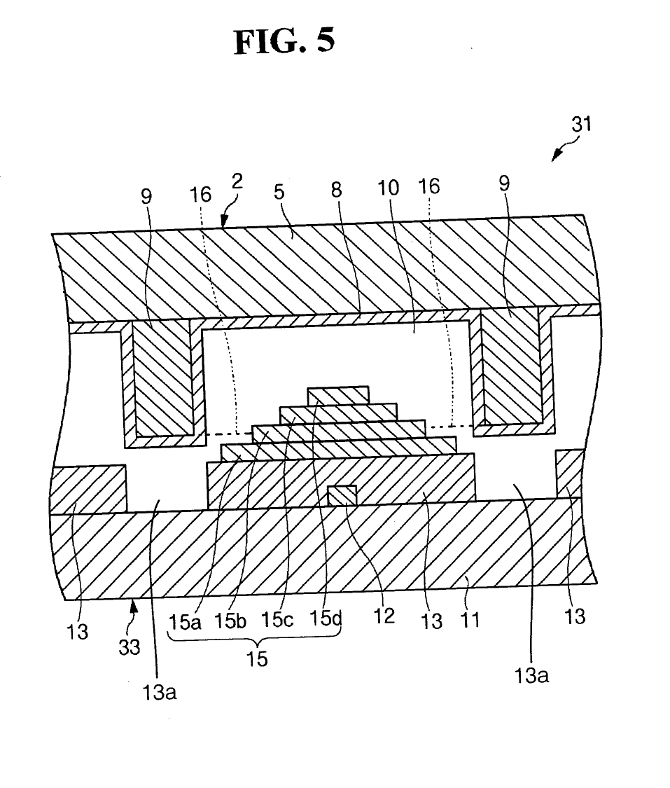

FIG. 5 is a partial cross-sectional view of a PDP in accordance with a third exemplary embodiment of the present invention. FIG. 5 is equivalent to the cross-section taken along line B-B of FIG. 1.

As shown in FIG. 5, in a PDP 31 according to the present exemplary embodiment, a white dielectric layer 13 disposed on a rear substrate 22 has grooves 13a formed at the portions corresponding to ribs 9. Preferably, the width of the grooves 13a is greater than the width of the ribs 9.

However, when viewed from the side of the front substrate 2, no grooves 13a are formed at the regions overlapping the X electrodes 6 and Y electrodes 7.

The other configurations of the present exemplary embodiment are identical to those of the first exemplary embodiment.

As such, since the grooves 13a are formed on the white dielectric layer, it is possible to reduce exhaust conductance upon exhausting the inside of a discharge space surrounded by the front substrate, rear substrate, and sealing frit in the process of manufacturing the PDP 31.

Accordingly, the inside of the discharge space can be exhausted more efficiently, and thereafter the space is filled with a discharge gas and sealed.

The other operations and effects of the present exemplary embodiment are identical to those of the first exemplary embodiment.

Hereinafter, a fourth embodiment of the present invention is described.

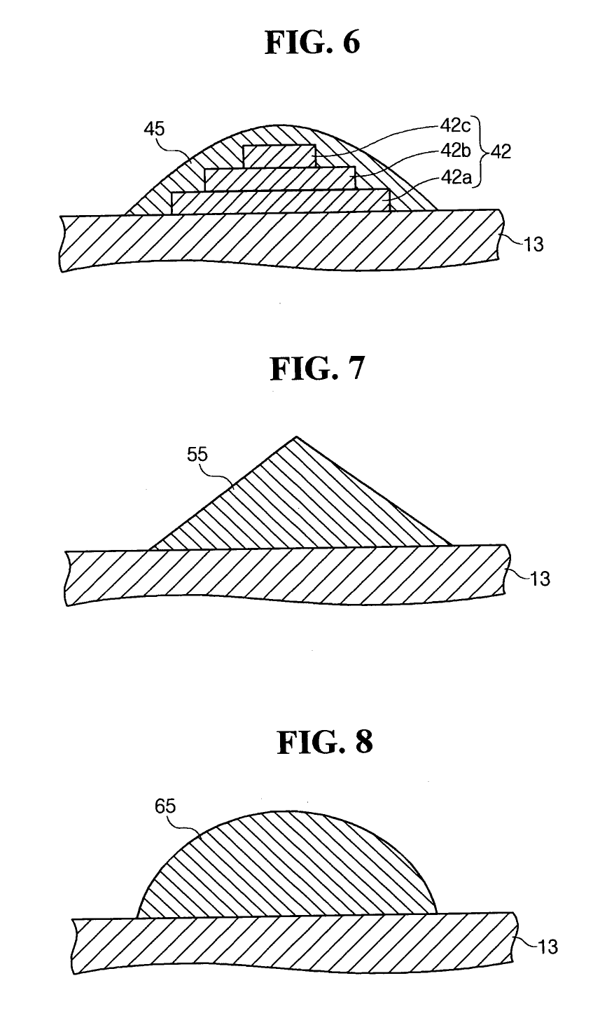

FIG. 6 is a partial cross-sectional view of a phosphor layer and its peripheral portions in a fourth exemplary embodiment of the present invention.

As shown in FIG. 6, in the present exemplary embodiment, a pyramid-shaped base portion 42 is formed on a white dielectric layer 13 of a rear substrate. The base portion 42 is made of a white dielectric material, and is formed in three layers in a cascade shape.

The base portion 42 has a first layer 42a being in contact with the white dielectric layer 13, and patterned in a rectangular shape, and a second layer 42b and a third layer 42c are formed in layers on the first layer 42a.

The outer circumference of the third layer 42c is positioned on an inner side of the outer circumference of the second layer 42b when viewed from the side of the front substrate. Thus, the outer circumference of the second layer 42b is positioned on an inner side of the outer circumference of the first layer 42a.

A phosphor layer 45 covering the base portion 42 is formed. At least part of the phosphor layer 45 is disposed between the X electrodes 6 and the Y electrodes 7 (refer to FIG. 2).

The other configuration of the present exemplary embodiment is identical to that of the first exemplary embodiment.

The base portion 42 is prepared by forming the first layer 42a on the white dielectric layer 13, then overlapping the second layer 42b thereon, and then overlapping the third layer 42c thereon.

The phosphor layer 45 can be formed by coating or dripping a phosphor material so as to cover the base portion 42, and then baking it.

The other manufacturing steps of the present exemplary embodiment are identical to those of the first exemplary embodiment.

As such, in the present exemplary embodiment, the base portion 42 is disposed between the white dielectric layer 13 and the phosphor layer 45, so that the bottom height of the phosphor layer 45 can be increased, the surface of the phosphor layer 45 can protrude toward the front substrate more easily, and the phosphor material can be saved.

The other operation and effects of the present exemplary embodiment are identical to those of the first exemplary embodiment.

Hereinafter, a fifth exemplary embodiment of the present invention is described.

FIG. 7 is a partial cross-sectional view of a phosphor layer and its peripheral portions in a fifth exemplary embodiment of the present invention.

As shown in FIG. 7, in the present exemplary embodiment, a phosphor layer 55 has a quadrangular pyramid shape, and when viewed in a first direction in which an X electrodes 6 and a Y electrodes 7 (refer to FIG. 2) extend, a cross-section of the phosphor layer 55 is formed in a triangular shape. The upper part of the phosphor layer 55 is disposed between the X electrodes 6 and the Y electrodes 7.

The other configuration of the present exemplary embodiment is identical to that of the first exemplary embodiment.

The phosphor layer 55 of a quadrangular pyramid can be formed by making the thickness of each layer of the phosphor layer 15 as small as the thickness of the phosphor layer 15 of the first embodiment, and increasing the number of layers so that each layer has a fine stepped portion.

The other manufacturing steps, operations, and effects of the present exemplary embodiment are similar to those of the first embodiment.

Hereinafter, a sixth embodiment of the present embodiment is described.

FIG. 8 is a partial cross-sectional view of a phosphor layer and its peripheral portions in a sixth exemplary embodiment of the present invention.

As shown in FIG. 8, in the present exemplary embodiment, a phosphor 65 is formed in a hemispherical shape, which is part of a sphere. When the phosphor layer 65 is viewed in a first direction, a cross-section of the phosphor layer 65 is formed in a hemispherical shape, which is part of a circle.

The upper part of the phosphor layer 65 is disposed between thr X electrodes 6 and the Y electrodes 7.

The other configurations of the present exemplary embodiment are identical to those of the first exemplary embodiment.

The phosphor layer 65 can be formed by dripping phosphor paste on a white dielectric layer 13 and then baking it.

Accordingly, in the present exemplary embodiment, the phosphor layer 65 is formed in a hemispherical shape, which is part of a circle, so that the surface of the phosphor layer 65 corresponds to a discharge path of a sustain discharge, thereby enhancing luminous efficiency.

The other manufacturing steps, operations, and effects of the present exemplary embodiment are similar to those of the first embodiment.

Hereinafter, a seventh embodiment of the present embodiment is described.

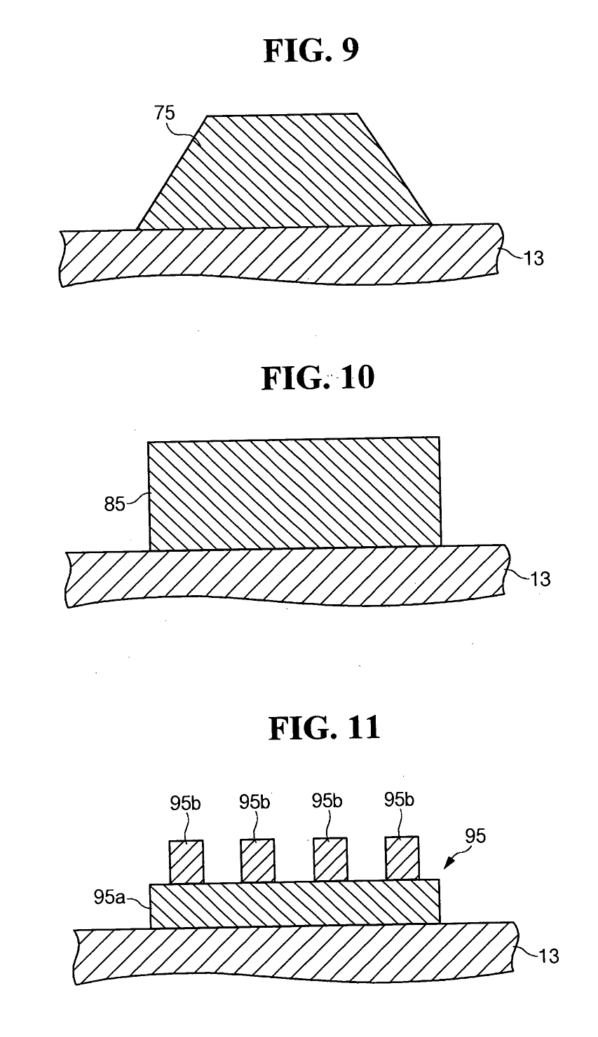

FIG. 9 is a partial cross-sectional view of a phosphor layer and its peripheral portions in a seventh exemplary embodiment of the present invention.

As shown in FIG. 9, in the present exemplary embodiment, a phosphor layer 75 is formed in a quadrangular pyramid shape. When the phosphor layer 75 is viewed in a first direction in which the X electrodes 6 and the Y electrodes 7 (refer to FIG. 2) extend, a cross-section of the phosphor layer 75 is formed in a trapezoidal shape. The upper part of the phosphor layer 75 is disposed between the X electrodes 6 and the Y electrodes 7.

The other configurations of the present exemplary embodiment are identical to those of the first exemplary embodiment.

The phosphor layer 75 of a quadrangular pyramid can be formed by making the thickness of each layer of the phosphor layer 15 the same as in the first embodiment, and increasing the number of layers so that each layer has a fine step.

The other manufacturing steps, operations, and effects of the present exemplary embodiment are similar to those of the first embodiment.

Hereinafter, an eighth embodiment of the present embodiment is described.

FIG. 10 is a partial cross-sectional view of a phosphor layer and its peripheral portions in an eighth exemplary embodiment of the present invention.

As shown in FIG. 10, a phosphor layer 85 has a rectangular shape, and when viewed in a first direction in which the X electrodes 6 and the Y electrodes 7 (refer to FIG. 2) extend, a cross-section of the phosphor layer 85 is a rectangular shape. The upper part of the phosphor layer 85 is disposed between the X electrodes 6 and the Y electrodes 7.

The other configurations, operations, and effects of the present exemplary embodiment are identical to those of the first exemplary embodiment.

Hereinafter, a ninth embodiment of the present embodiment is described.

FIG. 11 is a partial cross-sectional view of a phosphor layer and its peripheral portions in a ninth exemplary embodiment of the present invention.

As shown in FIG. 11, in the present exemplary embodiment, a phosphor layer 95 is formed on a white dielectric layer 13.

The phosphor layer 95 includes a rectangular portion 95a formed on the white dielectric layer 13 and a plurality of projections 95b formed on the rectangular portion 95a.

The projections 95b protrude from the top surface of the rectangular portion 95a, i.e., an upper surface facing a front substrate, to form protrusions and depressions. At least the upper part of the projections 95b is disposed between the X electrodes 6 and the Y electrodes 7.

The other configurations of the present exemplary embodiment are identical to those of the first exemplary embodiment.

In the present exemplary embodiment, since the protrusions and depressions are formed on the top surface of the phosphor layer 95, the surface area of the top surface of the phosphor layer 95 can be increased in comparison with the eighth exemplary embodiment. Accordingly, the conversion efficiency of converting ultraviolet rays into visible light can be improved.

The other operations and effects of the present exemplary embodiment are identical to those of the first exemplary embodiment.

In the fifth to ninth exemplary embodiments, like in the fourth exemplary embodiment, a base portion can be formed between the white dielectric layer 13 and the phosphor layer.

Accordingly, the phosphor layer can be formed in a desired shape more easily, and the amount of phosphor material used can be reduced.

Furthermore, in the fourth to ninth exemplary embodiments, like in the second exemplary embodiment, barrier ribs can also be formed on a rear substrate, and like in the third embodiment, grooves corresponding to the barrier ribs of the front substrate side can be formed on the white dielectric layer of the rear substrate.

Although the exemplary embodiments of the present invention have been described, it will be understood by those skilled in the art that the present invention is not limited to the described embodiments. Various changes and modifications can be made within the spirit and scope of the present invention as defined by the appended claims.

As described above, the PDP according to the present invention has the effect of enhancing luminous efficiency by shortening the distance between an ultraviolet ray generating portion and a phosphor layer by protruding the phosphor layer so as to be disposed between the X electrodes and Y electrodes.

Furthermore, the PDP according to the present invention has the effect of obtaining more visible light from ultraviolet rays by increasing the surface area by forming protrusions and depressions on the top surface of the phosphor layer.

Furthermore, the PDP according to the present invention has the effect of forming the phosphor layer in a desired shape more easily and saving a phosphor material of the phosphor layer by protruding a base portion on the surface of an insulating substrate and forming the phosphor layer so as to cover the base.

Furthermore, the PDP according to the present invention has the effect of reducing exhaust conductance in an exhaustion process for discharge gas injection by forming grooves on the white dielectric layer.

While the present invention has been described in connection with what is presently considered to be practical exemplary embodiments, it is to be understood that the present invention is not limited to the disclosed embodiments, but, on the contrary, is intended to cover various modifications and equivalent arrangements included within the spirit and scope of the appended claims.

What is claimed is:

1. A Plasma Display Panel (PDP), comprising:
a front substrate;
a rear substrate arranged to face the front substrate; and
a discharge gas contained between the front substrate and the rear substrate;
wherein the front substrate includes:
a transparent substrate; and
a plurality of X electrodes and Y electrodes extending in parallel to each other along a first direction on a surface of the transparent substrate facing the rear substrate, and arranged alternately to face each other with respect to a second direction crossing the first direction;
wherein the rear substrate includes:
an insulation substrate;
an address electrode extending along the second direction on a surface of the insulating substrate; and
a phosphor layer arranged on the surface of the insulating substrate; and
wherein at least part of the phosphor layer is arranged between the respective X electrodes and Y electrodes.

2. The PDP of claim 1, wherein the respective X and Y electrodes each include:
a bus electrode of a conductive material; and
a conductive material and a dielectric layer surrounding the bus electrode.

3. The PDP of claim 2, wherein at least part of the phosphor layer is arranged between the respective bus electrode of the X electrode and the bus electrode of the Y electrode.

4. The PDP of claim 1, wherein the phosphor layer protrudes toward the front substrate from the surface of the insulating substrate.

5. The PDP of claim 4, wherein a shape of a cross-section of the phosphor layer cut in a direction perpendicular to a horizontal surface of the rear substrate is at least one of a cascade, a triangle, a part of a circle, a trapezoid, or a rectangle shape.

6. The PDP of claim 5, wherein the phosphor layer further includes a plurality of projections protruding toward the front substrate, the plurality of protrusions having depressions spaced therebetween.

7. The PDP of claim 1, wherein the rear substrate includes a base portion protruding toward the front substrate from the surface of the insulating substrate, and wherein the phosphor layer covers the base portion.

8. The PDP of claim 7, wherein the base portion is arranged at a region between the respective X electrodes and Y electrodes on the surface of the insulating substrate.

9. The PDP of claim 8, wherein the base portion comprises layers in a pyramid shape.

10. The PDP of claim 7, wherein the base portion comprises a dielectric material.

11. The PDP of claim 1, wherein the front substrate further comprises ribs crossing the X electrodes and the Y electrodes on the surface of the transparent substrate, and wherein the ribs define discharge cells along with the X electrodes and the Y electrodes.

12. The PDP of claim 11, wherein the rear substrate further comprises barrier ribs on a side of the rear substrate corresponding to the X electrodes, the Y electrodes, and the ribs on the surface of the insulating substrate, and wherein the barrier ribs protrude to define discharge cells.

13. The PDP of claim 11, wherein the rear substrate includes a white dielectric layer covering the address electrode on the surface of the insulating substrate, and wherein the white dielectric layer includes grooves corresponding to the ribs.

14. The PDP of claim 11, wherein the grooves are wider than the ribs.
